(19) United States
(12) Patent Application Publication
(10) Pub. No.: US 2009/0090578 A1
(43) Pub. Date: Apr. 9, 2009

(54) PUSH FORWARD SHIFTER ASSEMBLIES

(76) Inventor: James D. Ross, Troy, OH (US)

Correspondence Address: DINSMORE & SHOHL, LLP, 1900 CHEMED CENTER, 255 EAST FIFTH STREET, CINCINNATI, OH, 45202, US

(21) Appl. No.: 12/245,084

(22) Filed: Oct. 3, 2008

Related U.S. Application Data
(60) Provisional application No. 60/977,176, filed on Oct. 3, 2007.

(51) Int. Cl. B60K 17/08

(52) U.S. Cl. 180/364

(57) ABSTRACT

Shifter assemblies to be mounted onto a motor vehicle are provided. According to one embodiment, a shifter assembly comprises a mounting plate configured to be mounted onto a motor vehicle adjacent to a floorboard. A pivot assembly is connected to the mounting plate. The shifter assembly also comprises a first shifter lever comprising a pedal portion configured to accept a first shifter pedal, and a linkage portion coupled for pivotal movement with respect to the pivot assembly. A linkage assembly comprising first and second end portions is coupled to the linkage portion of the first shifter lever at the first end portion, and is pivotally coupled to a shifter spline at the second end portion. The motor vehicle is upshifted by pivoting the first shifter lever in a forward direction and downshifted by pivoting a second shifter lever secured to the shifter spline in a forward direction.

### CROSS REFERENCE TO RELATED APPLICATIONS

This application claims the benefit of U.S. Provisional Application Ser. No. 60/977,176, filed on Oct. 3, 2007, for Systems and Methods for a Push Only Shifter.

### TECHNICAL FIELD

Embodiments generally relate to motor vehicle shifter assemblies, and, more particularly, to push forward shifter assemblies.

### BACKGROUND

Conventional motor vehicles such as motorcycles operate on a gear shifting mechanism that utilizes one or two shift pedals. To downshift a transmission using a conventional shifter, the rider pushes the downshift pedal with his or her foot, which causes a shifting rod to move forward toward the front of the motorcycle, thus shifting the transmission down a gear. To upshift using a conventional motorcycle shifter, the rider places his or her toe under the upshift pedal and lifts the upshift pedal by an upward force. The upward movement of the upshift pedal causes the shift rod to move backward toward the rear of the motorcycle, thus upshifting the transmission into a higher gear. Some shifter assemblies include a second heel shifter in which the transmission may be upshifted by pushing down on the heel shifter with the heel of the foot causing the shift rod to move backward toward the rear of the motorcycle, thus upshifting the transmission into a higher gear.

The conventional method of upshifting a motorcycle has many disadvantages. The lifting of the foot to upshift is not ergonomic and may cause the rider pain and fatigue. Pain may include, but is not limited to, aching of the foot, and toes (particularly the big toe) and discomfort in the hip and leg. This pain is especially pronounced during long rides. The upward pressure on the rider's foot may also cause damage to the rider's boot or shoe. Further, using an optional heel shifter can cause cramps or discomfort in the hip, knee or ankle of a rider from constantly lifting his or her foot and moving it backwards to push down on the shifter. Use of a heal shifter also limits the position a rider can place his or her foot. Particularly, those who have large feet may not have room to put their entire foot on the floorboard and may have to offset their foot in an uncomfortable position. Further, many riders have trouble learning to use a heel shifter so they may either remove it or not use it.

The conventional shifting method also presents safety issues when making a turn on a motor vehicle. For many riders, turning the motor vehicle and upshifting at the same time is challenging. Therefore, many riders wait to upshift until he or she is out of the turn, despite that the motor vehicle should have been shifted during the turn. This may cause damage to the transmission over time. A rider's foot may also slip, thereby causing the rider to lose control of the motor vehicle during the turn. Further, when upshifting during a turn or at anytime during the ride, the rider is required to move his or her foot up and sometimes off of the footboard, which may cause an unstable situation by not having force or pressure on the floorboard.

### SUMMARY OF THE INVENTION

It is against the above background that the present invention provides a number of advancements and advantageous over the prior art.

According to one embodiment, a shifter assembly to be mounted onto a motor vehicle is provided. The shifter assembly comprises a mounting plate configured to be mounted onto a motor vehicle adjacent to a floorboard. A pivot assembly is connected to the mounting plate. The shifter assembly also comprises a first shifter lever comprising a pedal portion configured to accept a first shifter pedal, and a linkage portion coupled for pivotal movement with respect to the pivot assembly. A linkage assembly comprising first and second end portions is coupled to the linkage portion of the first shifter lever at the first end portion, and is pivotally coupled to a shifter spline at the second end portion. According to the embodiment, a transmission of the motor vehicle is upshifted by pivoting the first shifter lever in a forward direction toward a front portion of the motor vehicle and downshifted by pivoting a second shifter lever that is secured to the shifter spline in a forward direction.

According to another embodiment, a shifter assembly is also provided. The shifter assembly comprises a mounting plate configured to be mounted onto the frame of a motor vehicle adjacent to a floorboard. A pivot assembly comprising a pivot post, a retainer cap and a shoulder bolt is connected to the mounting plate by a mounting fastener. The shifter assembly also comprises a first shifter lever comprising a pedal portion configured to accept a first shifter pedal, and a linkage portion coupled for pivotal movement with respect to the pivot assembly. The shifter assembly further comprises an adjustable linkage assembly comprising a male threaded rod end joint and a female threaded rod end joint. According to the embodiment, one of the rod end joints are coupled to the linkage portion of the first shifter lever, and the other rod end joint is coupled to a linkage adapter. The linkage adapter is secured to a shifter spline via a serrated hole. When forward/downward force is applied to the first shifter lever, the first shifter lever pivots about the shoulder bolt of the pivot assembly. A transmission of the motor vehicle is upshifted by pivoting the first shifter lever in a forward direction toward a front portion of the motor vehicle and downshifted by pivoting a second shifter lever that is secured to the shifter spline in a forward direction.

Further features and advantages of the invention will become more readily apparent from the following detailed description when taken in conjunction with the accompanying drawings.

### BRIEF DESCRIPTION OF THE DRAWINGS

The following detailed description will be more fully understood in view of the drawings, wherein like numerals indicate similar elements throughout the views:

FIG. 1 illustrates a left side profile view of a motor vehicle on which a shifter assembly is mounted according to one or more embodiments;

FIG. 2 illustrates a perspective view of a shifter assembly mounted on a motor vehicle according to one or more embodiments;

FIG. 3 illustrates a left side profile view of a shifter assembly according to one or more embodiments;

FIG. 4 illustrates a bottom view of a shifter assembly according to one or more embodiments;

FIG. 5 illustrates a left side profile view of a linkage adapter according to one or more embodiments;

FIG. 6A illustrates a left side profile view of a first shifter lever according to one or more embodiments;

FIG. 6B illustrates a top view of a first shifter lever according to one or more embodiments;

FIG. 7 illustrates a perspective view of a shifter assembly mounted on a motor vehicle according to one or more embodiments;

FIG. 8 illustrates a left side profile view of a shifter assembly wherein a second shifter pedal is depressed according to one embodiment; and

FIG. 9 illustrates a left side profile view of a shifter assembly wherein a first shifter pedal is depressed according to one embodiment.

The embodiments set forth in the drawings are illustrative in nature and are not intended to be limiting of the invention defined by the claims. Moreover, individual features of the drawings and the invention will be more fully apparent and understood in view of the detailed description. Some of the embodiments shown in the figures are not drawn to scale, and some parts are shown in shadow via dashed lines, or removed in order to show the features of the present invention.

### DETAILED DESCRIPTION

Generally, embodiments relate to shifter assemblies for motor vehicles. More particularly, embodiments relate to push-forward shifter assemblies that enable a rider to upshift a motor vehicle (e.g., a motorcycle, moped, three-wheeler, four-wheeler and the like) without lifting up on a pedal with his or her toe or pushing down with his or her heel. The shifter assembly may be mounted adjacent to a floorboard or to a foot peg that is placed proximate a shifter spline shaft of the motor vehicle so that the shifter pedals are within reach of the rider's foot and provide for an ergonomic riding experience.

According to one embodiment, the shifter assembly is provided in a kit that comprises a first shifter lever (i.e., the outside shifter lever) that is used in conjunction with an existing shifter lever such as an OEM shift lever (i.e., the inside shifter lever). Embodiments of the shifter assembly may also be included as standard hardware provided by the motor vehicle manufacturer and not provided as a kit. Both shifter levers operate by pushing forward on the respective pedals. Pushing forward/down on the second shifter pedal causes a shift rod to rotate in a forward direction toward the front of the motorcycle, thus downshifting the transmission of the motorcycle. Pushing forward/down on the first shifter pedal causes the shift rod to move backward toward the back of the motorcycle, thus upshifting the transmission of the motorcycle. Additionally, embodiments allow for the shifter assembly to be used as a regular shifter because the second shifter pedal may also be lifted up by the toe in a conventional manner to shift the transmission into a higher gear if desired. The two pedals are positioned proximate one another providing an ergonomic operation because a rider does not have to move his or her heel to upshift or downshift. Further, the two pedal configuration allows for a rider to upshift the motor vehicle without having to place his or her toe under the pedal and lift up.

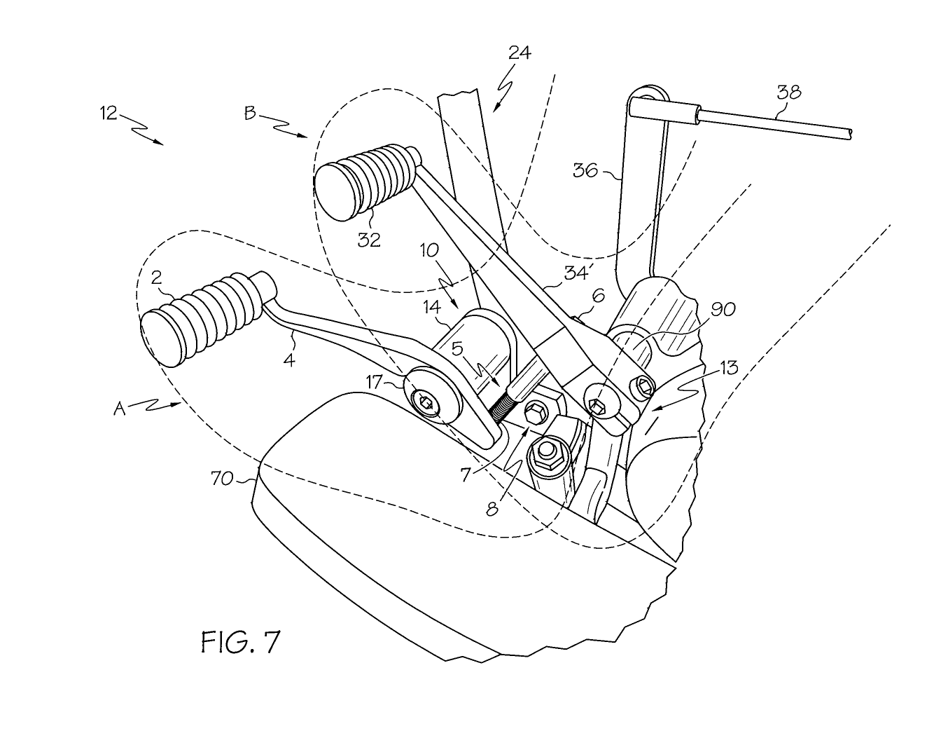

According to other embodiments, the shifter assembly comprises both a first and second shifter lever and rather than utilizing an existing second shifter lever. An example of such a shifter assembly is illustrated in FIG. 7 and will be described herein below. Similar to the aforementioned embodiment, the first shifter pedal, positioned on the outside, is used for upshifting and the second shifter pedal, positioned on the inside, is used for downshifting.

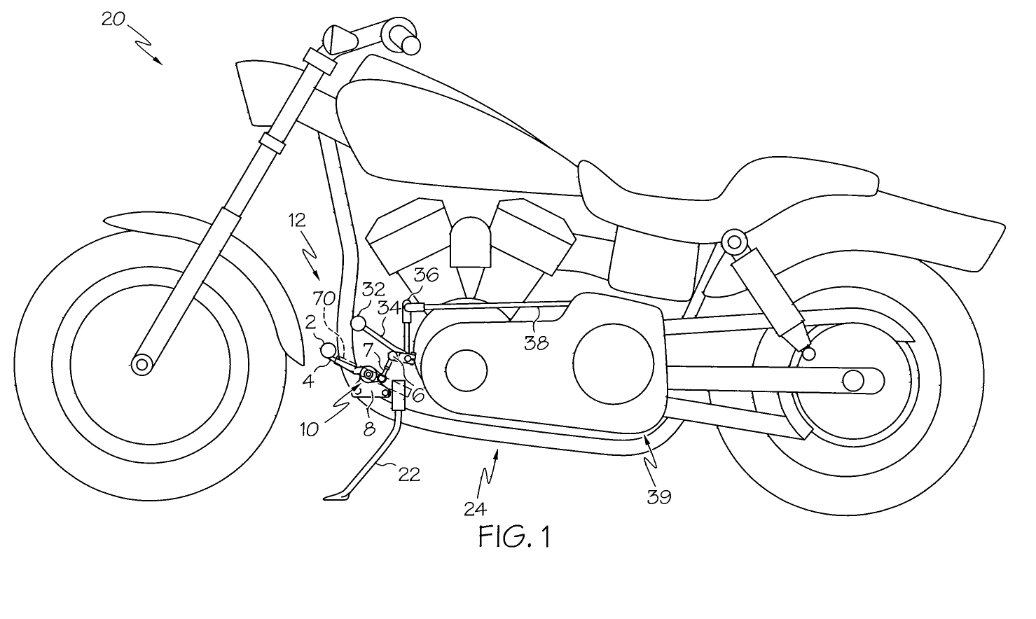

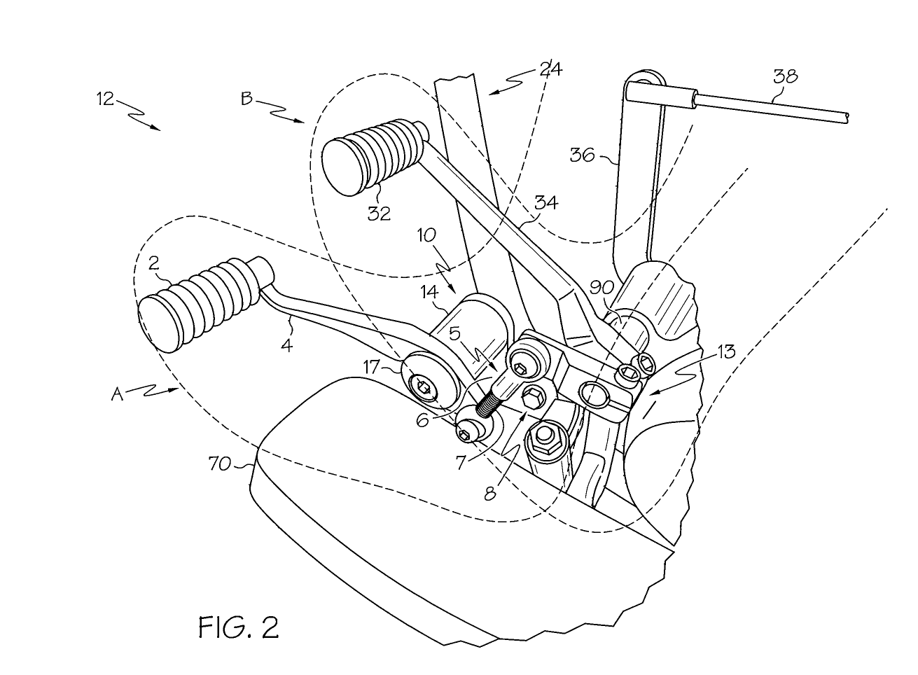

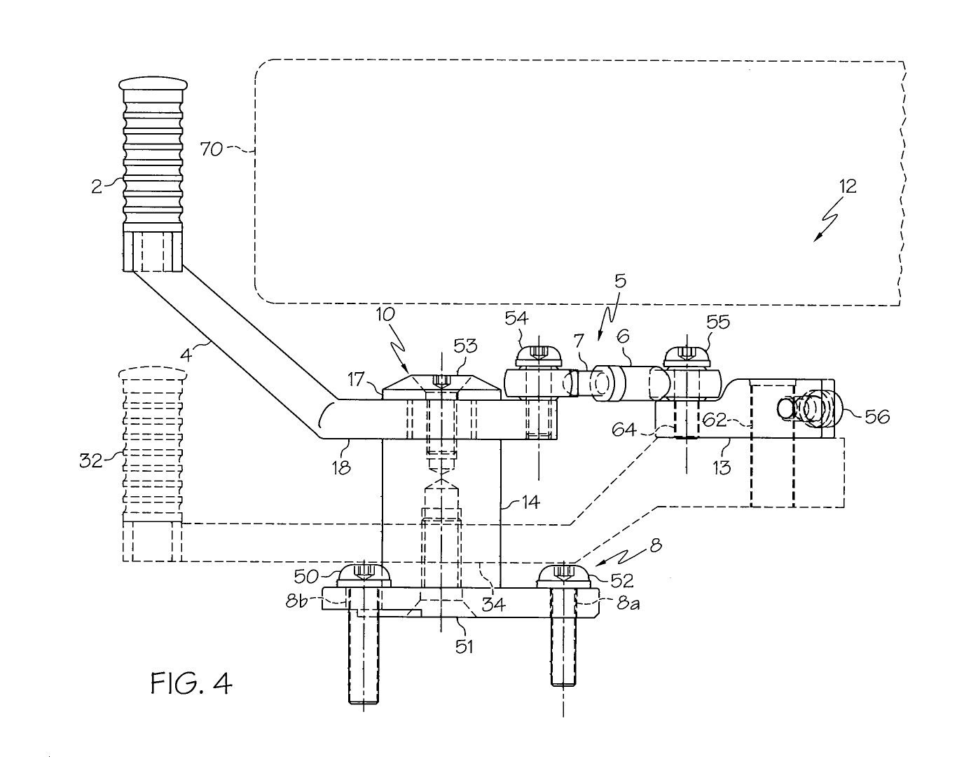

Referring initially to FIGS. 1 and 2, an exemplary shifter assembly 12 mounted to a motorcycle 20 is illustrated. The illustrated embodiment comprises a mounting plate 8, a first shifter lever 4, a pivot assembly 10, a linkage assembly 5 and a linkage adapter 13. The shifter assembly 12 may be mounted on the frame of the motor vehicle such that the shifter assembly 12 is positioned on the inside of the floorboard 70. Further, the shifter assembly 12 may be mounted such that the pivot assembly 10 is approximately level with the floorboard 70, and the first shifter lever 4 extends beyond a front edge of the floorboard 70. The first shifter lever 4 may possess a curve or bend such that the lever 4 bends around the front of the floorboard 70 (e.g., FIGS. 2 and 4). Some motor vehicles do not have a floorboard but rather a foot peg positioned near the a shifter spline shaft 90. The shifter assembly may be mounted proximate the foot peg such that the rider does not have to substantially move his or her foot to upshift or downshift.

The first shifter lever 4 is configured to accept a first shifter pedal 2, which may be any style of pedal. According to the illustrated embodiment, the second shifter lever 34 is an existing shifter lever that may be the original OEM lever or a custom lever/pedal, for example. The second shifter lever 34 is flipped 180 degrees from its normal orientation and re-affixed to shifter spline 90. As described in more detail below, the first shifter lever 4 may be pivotally attached to the shifter spline 90 via shifter assembly 5 and linkage adapter 13.

FIG. 2 also illustrates the positioning of the first shifter pedal 2 and the second shifter pedal 32 relative to one another. The first and second shifter pedals 2 and 32 may be positioned in approximately the same horizontal plane when viewed from above or below. The relative positioning of the illustrated embodiment provides the rider with an indication of which pedal he or she is pushing, thereby preventing the rider from mistakenly pushing the wrong pedal. Foot position A illustrates a relative foot position for upshifting and foot position B illustrates a relative foot position for downshifting. A rider does not have to move his or foot from the floorboard 70, or lift up on the second shifter lever 34 to either upshift or downshift, which provides for a comfortable and enjoyable ride. For example, to move from an upshift foot position A to a downshift position B, the rider simply rotates his or her foot about the heel from position A to position B.

Also referring to FIG. 2 and described in more detail below, the distance between the first shifter pedal 2 and the second shifter pedal 32 may be adjusted by adjusting the length of the linkage assembly 5. According to one embodiment, the linkage assembly may be adjusted by approximately a three quarters inch, for example. The relatively short linkage assembly 5, lack of relatively long linkages and close proximity of the first and second shifter levers 4 and 34 to one another provide for a solid upshifting experience with little undesirable vibrations and movements of the shifter assembly 12 during operation.

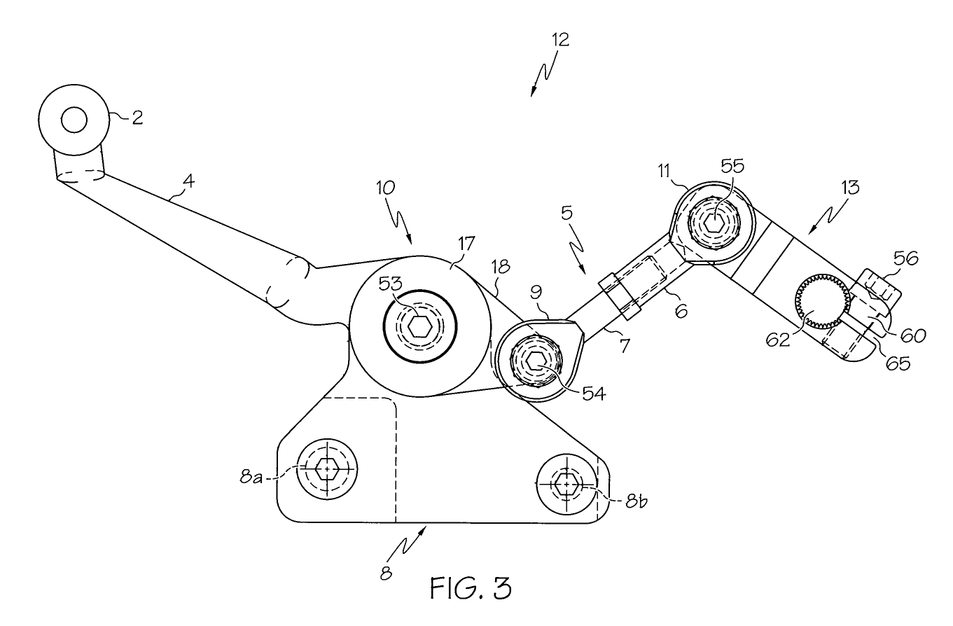

FIGS. 3 and 4, viewed in conjunction with FIG. 2, illustrate exemplary components according to one embodiment. FIG. 3 is a left side profile view of an exemplary shifter assembly, while FIG. 4 is a bottom view. The illustrated shifter assembly comprises a mounting plate 8 that is configured to attach the shifter assembly 12 onto the motor vehicle 20. The illustrated mounting plate 8 comprises mounting holes 8a and 8b that are positioned to align with existing holes on the motor vehicle 20. Therefore, the mounting plate 8 is configured to mount to the motor vehicle 20 without drilling any new or additional mounting holes. For example, mounting holes 8a and 8b may be aligned with mounting holes that are used for the mounting of the kickstand 22 or the engine guard. Bolts 50 and 52, or other similar mounting hardware, may be used to mount the mounting plate 8 and shifter assembly 12 to the motor vehicle. The number and location of the mounting holes 8a and 8b, as well as the shape of the mounting plate 8, may vary depending on the make, model and year of the motor vehicle. The mounting plate 8 may be machined of steel, such as 1018 cold rolled steel, for example. The components of may also be made of aluminum or other similar materials, such as composite materials.

According to the embodiment illustrated in FIG. 4, which is a bottom view, the pivot assembly 10 comprises a cylindrical post 14 that is configured to accept a mounting fastener 51, such as a flat head cap screw, for example, and a shoulder bolt 53. The mounting fastener 51 is used for mounting or attaching the pivot assembly to the mounting plate 8, and may be counter-sunk into the mounting plate 8 as illustrated in FIG. 4 or may be of any other appropriate configuration. The diameter of the cylindrical post 14 may be selected as desired. For example, the diameter may be approximately 1.50 inches and the length may be approximately 2.00 inches. Other dimensions are also possible and will depend on the desired style of the shifter assembly 12 in order to fit on other styles, makes and years for particular motor vehicles. The cylindrical post 14 may also be made of steel, such as 1144 steel, or other materials such as aluminum, for example. The pivot assembly 10 may also include a retainer cap 17, as described further below.

The first shifter lever 4 comprises a pedal portion that is configured to accept a pedal 2 for pivoting the lever 4, and a linkage portion 18 that is pivotally coupled to the pivot assembly 10 and more particularly, the cylindrical post 14. The pedal 2 may be included in the shifter assembly 12 according to one embodiment. According to other embodiments, the pedal 2 is not included in the shifter assembly 12 but is rather supplied by the user. The lever 4 may be pivotally coupled to the cylindrical post 14 via the shoulder bold 53, retainer cap 17 and other washers and related hardware (not illustrated). According to the illustrated embodiment, the linkage portion 18 of the first shifter lever 4 is retained between the retainer cap 17, which may be coated with chrome for aesthetic purposes, and the cylindrical post 14. The lever 4 pivots about the unthreaded portion of the shoulder bolt 53 at the linkage portion 18 as a forward/downward force is applied to the pedal 2.

The first shifter lever 4, which may be cast or machined steel or aluminum, may be angled or arcuate as illustrated in FIG. 4 and thereby curve around a front edge of the floorboard 70. The first shifter lever may also be lengthened as to extend forward for riders with longer legs, or for those who desire to have the shifter pedal in a more forward position. Further, to provide for optimal operational positioning of the first shifter pedal 2, the first shifter lever 4 may possess a length and an angle or arc such that the pedal 2 does not extend beyond the outer edge of the floorboard 70, according to some embodiments. The first and second shifter pedals 2 and 32 are aligned in substantially the same horizontal plane as viewed from above or below. Additionally, the distance between the first and second shifter pedals 2 and 32 may be greater than or less than the embodiment illustrated in FIG. 4. As illustrated in FIG. 2, the first shifter lever 4 and the floorboard 70 are inclined at similar angles.

The linkage portion 18 may be further configured to be coupled to a linkage assembly 5 having a first and second end portion 7 and 6. According to some embodiments, the linkage assembly 5 may be a single linkage and, according to other embodiments, the linkage assembly may consist of one or more components. The exemplary linkage assembly 5 illustrated in FIGS. 3 and 4 comprises two separate end rod joints 9 and 11. Other joints and linkage configurations are also possible. More particularly, the first end portion of the linkage assembly 5 comprises a rod end joint 9 having a male threaded portion and the second end portion comprises a rod end joint 11 having a female threaded portion. The two rod end joints 9 and 11 are mated together via the threaded portions as illustrated, and the length of the linkage may be adjusted to adjust the distance between the first and second pedals 2 and 32, as described herein below. The first portion 7 of the linkage assembly 5 may be coupled to the linkage portion 18 of the first shifter lever 4 via the rod end joint 9 and a fastener 54, as well as any additional hardware, such as washers.

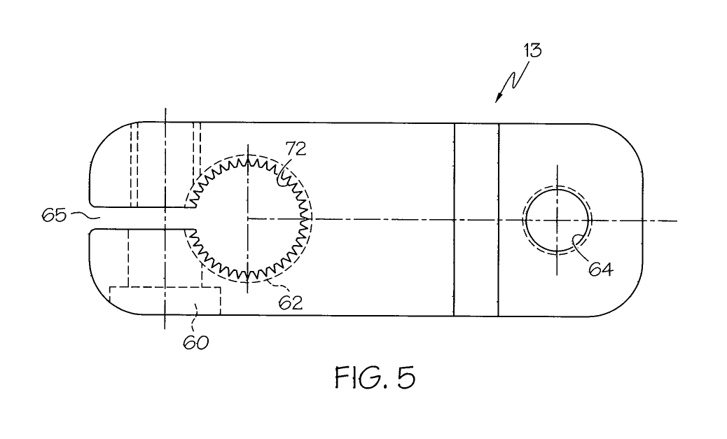

According to some embodiments, the linkage assembly is pivotally coupled to the shifter spline 90 via a linkage adapter 13. An exemplary linkage adapter 13 is illustrated in FIG. 5. The illustrated linkage adapter 13 has a linkage assembly connection hole 64 for accepting a fastener such as a screw 55, wherein the rod end joint 11 of the linkage assembly 5 is coupled to the linkage adapter 55. The linkage adapter 13 may also comprise a serrated hole 62 and a gap 65 at an end opposite of the hole 64. The serration 72 of the hole 62 is configured to secure the linkage adapter 13 to the shifter spline 90. A set screw 56 in bored hole 60 may be provided to apply a clamping force upon the gap 65, thereby effectively securing the linkage adapter 13 to the shifter spline 90. The linkage adapter 13, which also may be made of steel, such as 1018 cold rolled steel or other similar materials, for example, may be tapered from the serrated hole 62 to the linkage assembly connection hole 64.

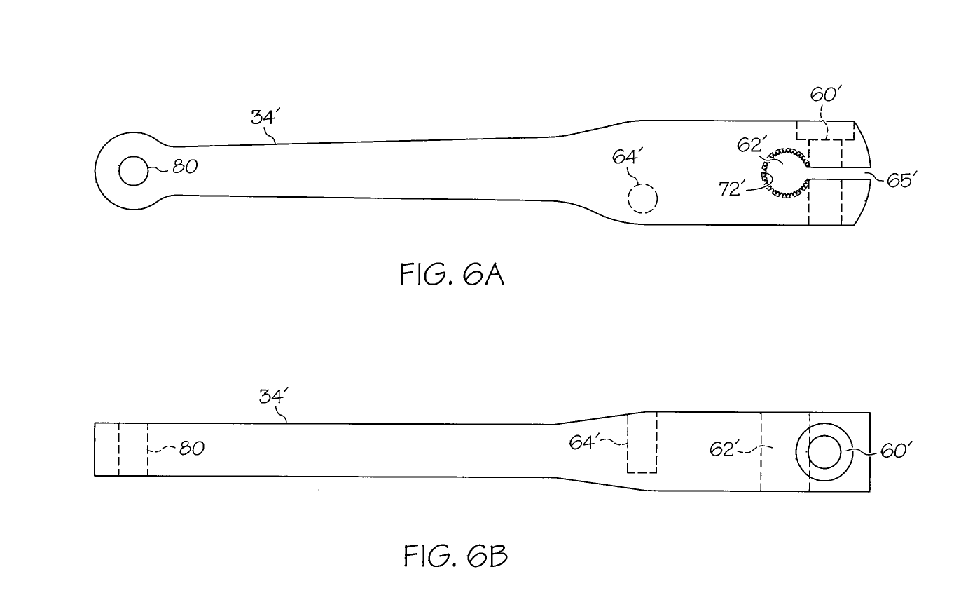

According to other embodiments, the shifter assembly 12 may comprise a second shifter lever 34′ that is not an existing or an original shifter, but is rather a modified lever that incorporates the linkage adapter 13 described above, and is directly coupled to the linkage assembly 5. FIG. 6A is a left profile view of an exemplary second shifter lever 34′, while FIG. 6B provides a top view. As may be seen in FIGS. 6A and 6B, the second shifter lever 34′ comprises a serrated hole 62′, linkage assembly connection hole 64′, a recess 60′ for a set screw, and a gap 65′. According to the embodiment illustrated in FIG. 7, the second shifter lever 34′ of this embodiment is attached to the shifter spline 90 via the serration 72′ of serrated hole 62′ and is coupled to the linkage assembly 5 at 64′. According to this embodiment, the linkage adapter 13 component may therefore not be required. An end cap may be secured to the shifter spline shaft 90 for aesthetic purposes.

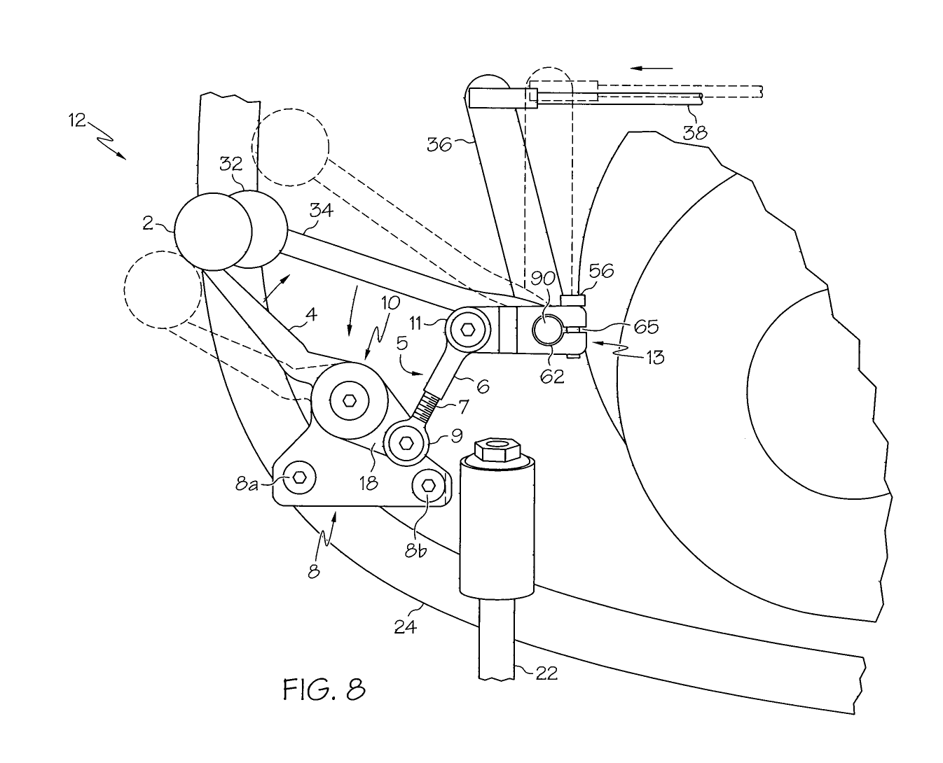

FIG. 8 illustrates an exemplary shifter assembly 12 going from a neutral position (shown partially in shadow) to a downshifted position when downward/forward force is applied to second shifter pedal 32 (e.g., foot position A in FIGS. 2 and 7). The rider pushes second shifter pedal 32 downward with his or her foot, which causes second shifter lever 34 to rotate down in a counterclockwise motion. This downward action also causes the first shifting pedal 2 and first shifting lever 4 to rise in a clockwise motion because the linkage adapter 13 is also rotated, which in turn causes linkage assembly 5 to push downward on the linkage portion 18 of the first shifter lever 18. The rotation of the first shifter lever 4 about the pivot assembly 10 causes the first shifter pedal 2 to rise. By way of example and limitation, the first shifter pedal 2 and second shifting pedal 32 may be configured to move up and down approximately 1 inch from the neutral position, respectively, according to one or more embodiments. Further, by pressing down on second shifting pedal 32, the shifter spline shaft 90 is rotated counterclockwise. When pushing second shifting pedal 32 down, the rotating shifter spline shaft 90 (which is also connected to a vertical shifting rod 36) moves the vertical shifting rod 36 in a counterclockwise direction toward the front of the motor vehicle 20, which pulls a shifting rod 38 that is connected to the transmission of the motor vehicle 20, thereby downshifting the transmission.

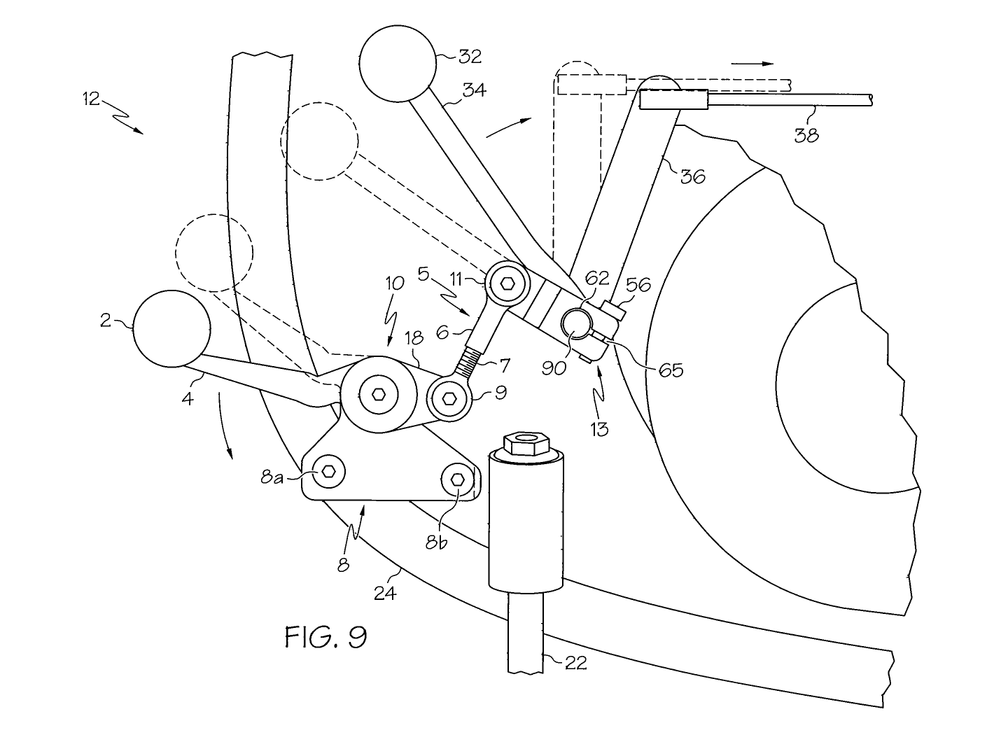

FIG. 9 illustrates an exemplary shifter assembly 12 going from a neutral position (shown partially in shadow) to a downshifted position when downward force is applied to the first shifter pedal 2 (e.g., foot position B in FIGS. 2 and 7). As the rider pushes the first shifter pedal 2 downward with his or her foot, the first shifter lever 4 rotates downward in a counter-clockwise motion. As the first shifter lever 4 is rotated about pivot assembly 10, the linkage portion 18 rises and causes the linkage assembly 5 to also rise and pivot at 9. According to the illustrated embodiment, the rising linkage assembly 5 pushes upward on the linkage adapter 13 and pivot at 11. This causes the shifter spline shaft 90 and the attached second shifter lever 34 to rotate clockwise. Further, when pushing the first shifting pedal 2 in a forward/downward direction, the rotating shifter spline shaft 13 rotates vertical shifting rod 36 in a clockwise direction, which pushes shifting rod 38 toward the rear of the motor vehicle 20, thereby upshifting the transmission.

According to one embodiment, the distance between the two pedals 2 and 32 in a neutral position may be approximately 2⅝ inches. For example and not limitation, upon upshifting the distance is increased to 4½ inches, and upon downshifting the distance is decreased to ¾ inches. However, this distance may be adjusted by the rider to accommodate the rider's personal preference. Some riders may desire to have the first shifter pedal 2 rise to meet his or her foot when depressing the second shifter pedal 32 to ensure that the second shifter pedal 32 was depressed sufficiently. However, other riders may not prefer to have the first shifter pedal 2 rise to meet his or her foot upon pushing second shifter pedal 32 and may therefore desire to increase the distance between the pedals 2 and 32. For example, linkage assembly 5 may be lengthened to increase the neutral-position distance between the pedals 2 and 32, or shortened to decrease the neutral-position distance between the pedals 2 and 32. In the embodiment illustrated in FIG. 3, the adjustment is made by adjusting the threaded connections of linkage assembly portions 6 and 7. However, it is contemplated that other adjustment methods and hardware may be utilized.

Similarly, the horizontal distance between the pedals 2 and 32 provides for a more ergonomic ride and also aids in indicating which pedal is being depressed. Upon assembly of one embodiment, an existing or conventional second shifter lever 34 is removed from the shifter spline shaft 90 and rotated 180 degrees such that the second shifter lever 34 is angled toward the motor vehicle. This may provide approximately ¾ inch horizontal distance between the pedals 2 and 32 depending on the type of second shifter lever 34 used, for example.

To further inform a rider about which pedal he or she is pushing, and to prevent mistakenly pushing the wrong pedal, the force required to depress one pedal may be noticeably different from the force required to depress the other pedal. For example, the force required to push the second shifter pedal 32 may be noticeably less than the force required to push the first shifter pedal 2. For example and not limitation, the force required to push the second shifter pedal 32 at foot position B may be 15 lbs of force, while the force required to push the first shifter pedal 2 at foot position A may be 39 lbs of force. The force required for the pedals may be adjusted by adjusting the length of linkage assembly 5.

Because of the compact nature of the shifter assembly 12 and its position on the motor vehicle, embodiments also allow the floorboard 70 to be raised or lowered, thus allowing a rider to rest his or her foot on the floorboard 70 at the most optimal position, further adding comfort to the ride. More specifically, the shifter assembly 12 may allow a rider to rest his or her foot on the floorboard 70 at all times, without requiring a lifting of the foot off of the floorboard 70 to shift. Further, because of the positioning and configuration of the shifter assembly 12, a majority of the first shifter lever 4 and pivot assembly 10 may be hidden by the floorboard 70, providing a sleek look.

For the purposes of describing and defining the present invention it is noted that the terms “approximately” and “substantially” are utilized to represent the inherent degree of uncertainty that may be attributed to any quantitative comparison, value, measurement, or other representation. The terms “approximately” and “substantially” are also utilized herein to represent the degree by which a quantitative representation may vary from a stated reference without resulting in a change in the basic function of the subject matter at issue.

It is noted that recitations herein of a component of the present invention being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

The above description and drawings are only to be considered illustrative of exemplary embodiments, which achieve the features and advantages of the present invention. The invention is not to be considered as being limited by the foregoing description and drawings, but is only limited by the scope of the appended claims.

What is claimed is:

1. A shifter assembly for a motor vehicle having a transmission and a floorboard, a foot peg or a combination thereof, the shifter assembly comprising:
a mounting plate configured to be mounted onto the motor vehicle adjacent the floorboard or foot peg;
a pivot assembly connected to the mounting plate;
a first shifter lever comprising a pedal portion configured to accept a first shifter pedal and a linkage portion coupled for pivotal movement with respect to the pivot assembly; and
a linkage assembly comprising a first and second end portion, wherein the first end portion is coupled to the linkage portion of the first shifter lever and the second end portion is pivotally coupled to a shifter spline;
wherein the transmission of the motor vehicle is upshifted by pivoting the first shifter lever in a forward direction and downshifted by pivoting a second shifter lever that is secured to the shifter spline in a forward direction.

2. A shifter assembly as claimed in claim 1 wherein the mounting plate comprises at least two mounting holes that are aligned with existing motor vehicle mounting holes such that the mounting of the shifter assembly onto the motor vehicle does not require the drilling of additional mounting holes into the motor vehicle.

3. A shifter assembly as claimed in claim 2 wherein the at least two mounting holes are aligned with at least one of a kickstand mounting hole or an engine guard mounting hole.

4. A shifter assembly as claimed in claim 1 wherein the shifter assembly is positioned and configured such that the transmission is operably upshifted and downshifted without requiring a user of the motor vehicle to lift his or her heel off of the floorboard or the foot peg.

5. A shifter assembly as claimed in claim 1 wherein when the first lever is pivoted in a forward direction, the second shifter lever is pivoted in an opposite direction, causing a horizontal shifting rod to move in a direction toward a rear portion of the motor vehicle, thereby upshifting the transmission.

6. A shifter assembly as claimed in claim 1 wherein the force required to pivot the first shifter lever in a forward direction is different than the force required to pivot the second shifter lever in a forward direction.

7. A shifter assembly as claimed in claim 1 wherein the length of the linkage assembly is adjustable so that the distance between the first shifter pedal and a second shifter pedal connected to the second shifter lever may be increased or decreased.

8. A shifter assembly as claimed in claim 1 wherein:
the length of the linkage assembly is shorter than the length of the first shifter lever; and
the linkage assembly is positioned at an angle between 5 degrees and 30 degrees relative to vertical.

9. A shifter assembly as claimed in claim 1 wherein the linkage portion of the first shifter lever is substantially straight with respect to the floorboard, and a remainder of the first shifter lever curves around a front edge of the floorboard and does not extend beyond a plane defined by an outside edge of the floorboard.

10. A shifter assembly as claimed in claim 1 wherein:
the first end portion of the linkage assembly comprises a first rod end joint having a threaded male portion;
the second end portion of the linkage assembly comprises a second rod end joint having a threaded female portion; and
the first and second rod end joints are mated together via the threaded male and female portions.

11. A shifter assembly as claimed in claim 1 wherein the shifter assembly is provided as a kit.

12. A shifter assembly as claimed in claim 11 wherein:
the second shifter lever is an existing shifter lever and not provided in the kit; and
the shifter assembly further comprises a linkage adapter configured to pivotally couple the linkage assembly to the shifter spline, the linkage adapter having a serrated hole configured to secure the linkage adapter to the shifter spline and a linkage assembly mounting hole for coupling the linkage assembly to the linkage adapter.

13. A shifter assembly as claimed in claim 1 wherein the second shifter lever comprises an integral linkage adapter portion configured to pivotally couple the linkage assembly to the shifter spline, the integral linkage adapter having a serrated hole configured to secure the linkage adapter to the shifter spline and a linkage assembly mounting hole for coupling the linkage assembly to the integral linkage adapter portion.

14. A shifter assembly as claimed in claim 1 wherein the pivot assembly comprises:
a cylindrical post;
a mounting fastener for connecting the cylindrical post to the mounting plate;
a retainer cap positioned on a face of the cylindrical post opposite the mounting plate such that the linkage portion of the first shifter lever is positioned between the retainer cap and the face of the cylindrical post; and
a shoulder bolt for securing the retainer cap and the first lever to the cylindrical post and for providing an axis about which the first shifter lever pivots.

15. A shifter assembly as claimed in claim 1 wherein the shifter assembly is configured to be mounted onto the motor vehicle such that the shifter assembly is positioned on the inside of the floorboard, the pivot assembly is substantially level with the floorboard and the first shifter lever extends beyond a front edge of the floorboard.
